(19) United States
(12) Patent Application Publication
(10) Pub. No.: US 2013/0016873 A1
(43) Pub. Date: Jan. 17, 2013

(54) W Dome Speakers

(71) Applicant: Mark Trainer, Northridge, CA (US)

(72) Inventor: Mark Trainer, Northridge, CA (US)

(73) Assignee: STRATA AUDIO LLC, Westlake Village, CA (US)

(21) Appl. No.: 13/547,418

(22) Filed: Jul. 12, 2012

Related U.S. Application Data
(60) Provisional application No. 61/506,893, filed on Jul. 12, 2011.

(51) Int. Cl. H04R 1/00

(52) U.S. Cl. 381/430; 381/423

(57) ABSTRACT

A W-shaped radiating surface for a transducer assembly is described. The radiating surface has a center portion and an outer portion. The center portion is disposed in the center of a voice coil former and has a first sloping region and a second sloping region that meet at a first angle. The outer portion is disposed outside the center of the voice coil former and has a third sloping region and a fourth sloping region, which meet at a second angle. The center portion couples with the outer portion at a third angle to form a radiating surface that has a W-shaped cross section.

This application claims the benefit of priority to provisional application Ser. No. 61/506893 filed on Jul. 12, 2012, which is incorporated herein by reference.

### FIELD OF THE INVENTION

The field of the invention is audio transducers.

### BACKGROUND

The background description includes information that may be useful in understanding the present inventive subject matter. It is not an admission that any of the information provided herein is prior art or relevant to the presently claimed inventive subject matter, or that any publication specifically or implicitly referenced is prior art.

Transducers (i.e., audio loudspeakers) are well known and generally comprise a radiating surface (e.g., dome, diaphragm, membrane, cone, etc) attached to a voice coil former (also referred to as a bobbin). The voice coil former is attached to a voice coil, which is suspended in a static magnetic field. An amplifier is electrically coupled to the voice coil and provides a current (i.e., signal) to the voice coil. The current produces an electromagnetic field around the coil, which interacts with the static magnetic field and causes the coil to vibrate up and down. The coil, in turn, causes the dome to vibrate, which vibrates the surrounding air to produce audio waves.

Transducers are found in a variety of electronic devices, such as smart phones, laptops, television sets, radios, and recording devices. As electronics become smaller and more compact, there is a greater need for “mini-transducers” (e.g., shallow speakers, low profile speakers) that are small enough to fit into a compact device while still maintaining adequate volume output and sound quality. Since the amount of sound produced by a speaker is directly related to the speaker's “excursion” (i.e., how far forward and backward a speaker can move), speaker designers face significant challenges when designing mini-transducers.

Numerous mini-transducer designs are known. See, for example, US20080232633, US20090169049, US20100166249, U.S. Pat. No. 7,599,511, U.S. Pat. No. 7,570,780, U.S. Pat. No. 7,433,485, and US20100303278.

All materials and references cited herein are incorporated by reference to the same extent as if each individual reference were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In each of these references, the transducer diaphragm is attached to a voice coil former at either the top or the bottom extremity of the diaphragm. Consequently, the center of mass of the moving components (e.g., voice coil former and diaphragm) is fixed at a specific location. Those of ordinary skill in the art have failed to contemplate a general diaphragm design that allows the designer and/or manufacturer to vary the center of mass and attachment point to the voice coil former.

Thus, there is still a need for a mini-transducer diaphragm design that allows for variable placement of the center of mass with respect to a voice coil former.

### SUMMARY OF THE INVENTION

The inventive subject matter provides apparatus, systems, and methods in which a transducer diaphragm comprises a center portion and an outer portion. The center portion is disposed in a center of a voice coil former and has a first sloping region and a second sloping region that meet at a first angle. The outer portion is disposed outside the center of the voice coil former and has a third sloping region and a fourth sloping region, which meet at a second angle. The center portion couples with the outer portion at a third angle and, thus, a cross section of the center and outer portions create a W-shape.

In some embodiments of the inventive subject matter, the center portion is convex. In other embodiments, the center portion comprises a dome diaphragm. The center portion and outer portion can be one integral unit. Alternatively, the center portion and outer portion can be two separate units affixed together at a point outside the center of the voice coil former. The center portion and outer portion could also have an oval circumference. In still other embodiments, the outer potion comprises a surround suspension.

In certain embodiments, the first sloping region can have a constant slope. The second sloping region can be concave, convex, or can have a constant slope. In other embodiments, the second sloping region has a length and slope that is configured to place a center of mass of the diaphragm below a height of the voice coil former.

In some embodiments, the first sloping region and the second sloping region can be one integral unit. Alternatively, the first sloping region and the second sloping region can be two separate units affixed together at a point outside the center of the voice coil former.

In some embodiments, the first, second and third angles are 45 degrees. In other embodiments, the first, second and third angles are acute angles. In still other embodiments, the third angle can be configured to couple with the voice coil former.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A is an exploded view of a mini transducer assembly.

FIG. 1B is a perspective view of the transducer assembly in FIG. 1.

FIG. 2A is cross sectional view of a diaphragm design.

FIG. 2B is a perspective view of the diaphragm design of FIG. 2A.

FIG. 3 is cross sectional view of another diaphragm design.

FIG. 4A is a cross sectional view of a W-shaped diaphragm design.

FIG. 4B is a perspective view of the W-shaped diaphragm design of FIG. 4A assembled in a speaker housing.

FIG. 4C is a cross sectional view of the W-shaped diaphragm design and speaker housing of FIG. 4B.

FIG. 5 is a cross sectional view of three different W-shaped diaphragm designs.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

One should appreciate that the disclosed devices and techniques provide many advantageous technical effects, including improved diaphragm designs for audio transducers. More specifically, the improved diaphragm designs described herein allow designers to easily adjust the diaphragm's attachment points to a voice coil former and the location of the center of mass.

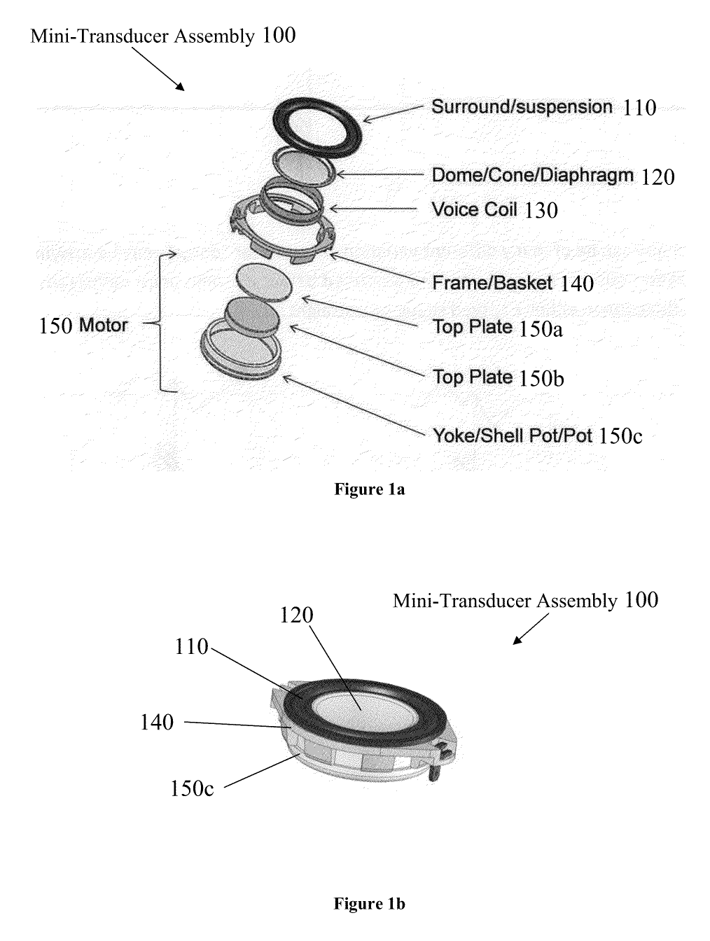

FIG. 1A shows an exploded view of a mini-transducer assembly 100, comprising a surround/suspension 110, a diaphragm 120, a voice coil 130, a frame 140, and a motor 150. Suspension 110 is configured to provide diaphragm 120 with mobility. Diaphragm 120 is configured with sufficient stiffness to maintain its shape when vibrated by voice coil 130.

FIG. 1B shows a perspective view of mini-transducer assembly 100. FIGS. 1A and 1B illustrate the basic components of a mini-transducer assembly.

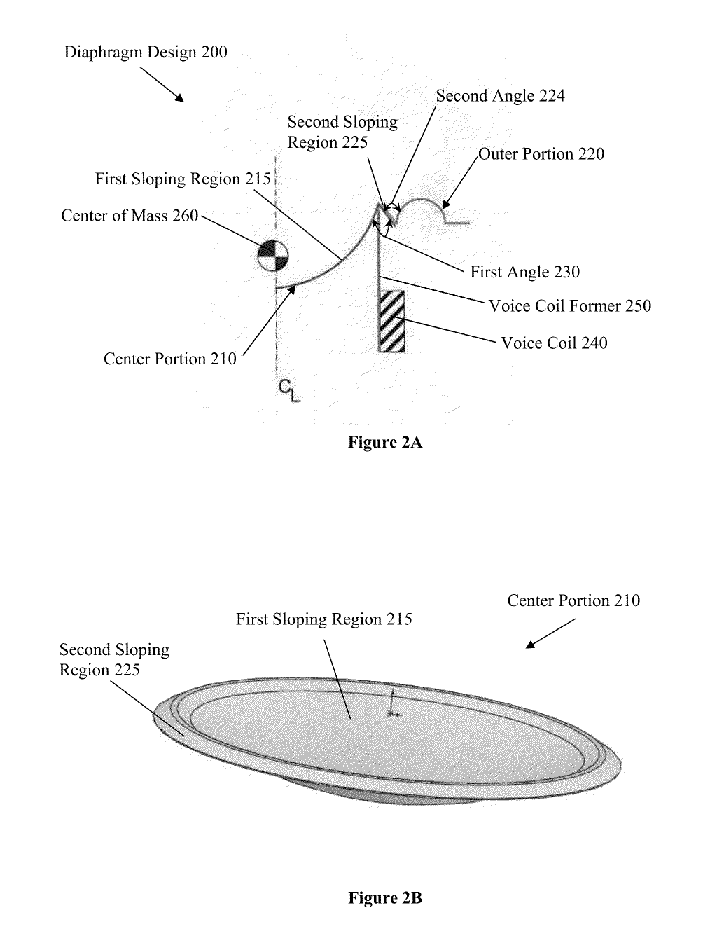

FIG. 2A shows a cross-sectional view of a diaphragm design 200 having a center portion 210 and an outer portion 220, which meet at first angle 230. Center portion 210 has a first sloping region having a concave shape disposed in the center of voice coil former 250. FIG. 2B shows a perceptive view of center portion 210. Center portion 210 is configured with a material having sufficient stiffness to act as a diaphragm in displacing air and creating sound waves. Outer portion 220 has a second sloping region 225, having an opposite slope as first sloping region 215. First angle 230 is formed by the opposite sloping directions of first and second sloping regions 215 and 225. Outer portion 220 is configured with a material suitable for functioning as a surround/suspension. In additional, outer portion 220 is shaped with second angle 224.

As used herein, the term “sloping” refers to a gradient of a line or surface with respect to a centerline (CL). In FIG. 2B, for example, a line or surface that is substantially perpendicular to the centerline will have no slope, and a line or surface that is substantially parallel to the centerline will have a maximum slope.

Voice coil 240 has a voice coil former 250 that couples with angle 230. Former 250 can couple with center portion 210 and outer portion 220 using an adhesive or any other conventional fastening method. Voice coil former 250 couples to center portion 210 at the “top extremity” of first sloping region 215. Center of mass 260 is the center of mass of the moving components (e.g., center portion 210, outer portion 220, voice coil 240, voice coil former 250) and is shown at a distance slightly below the height of voice coil former 250. A centerline (CL) is shown, representing a line of symmetry. From a perspective view, the voice coil former 250 has a cylindrical shape and the outer portion 220 has a dome shape.

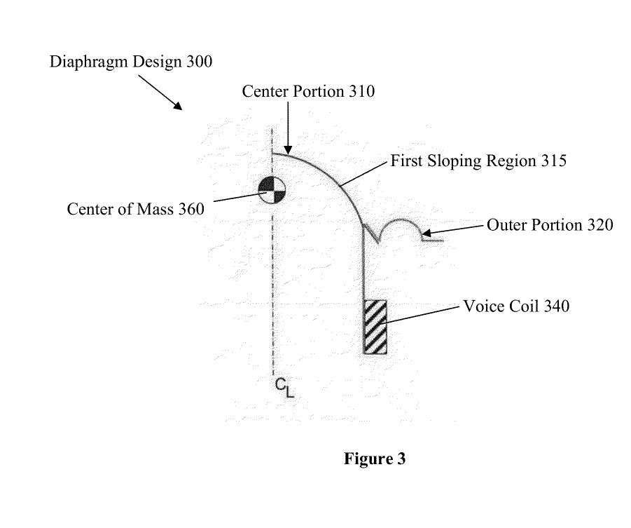

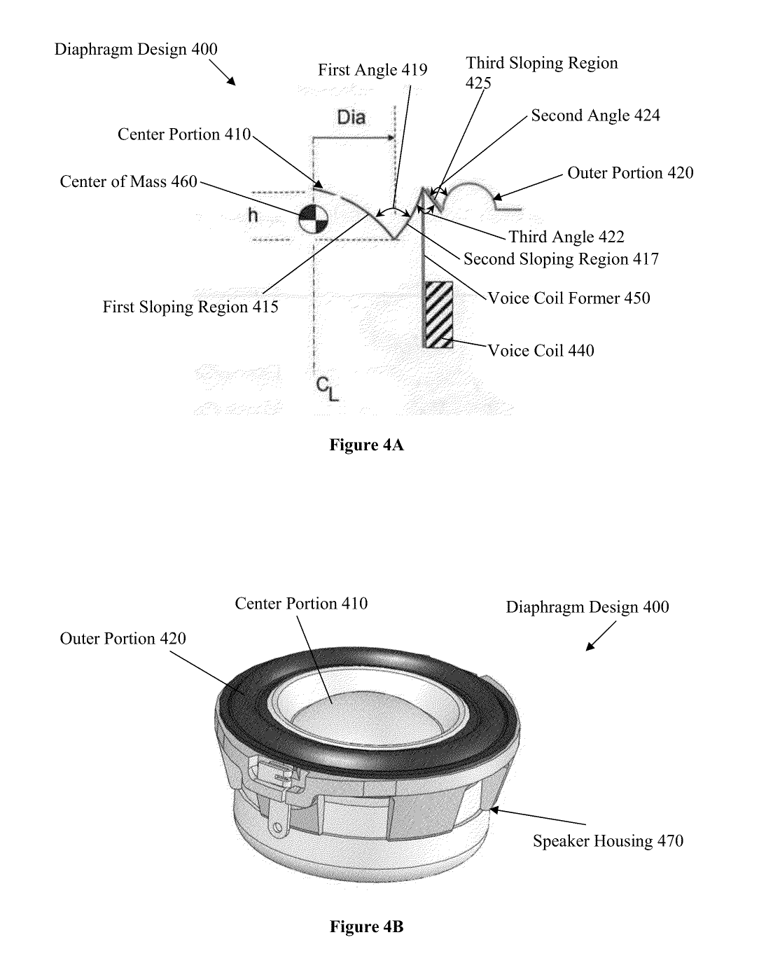

FIG. 3A shows a cross-sectional view of diaphragm design 300. Design 300 is similar to design 200 except that center portion 310 has a first sloping region 315 that is convex rather than concave. The convex shape of center portion 310 places center of mass 360 slightly above voice coil former 350. Design 300 is also distinct from design 200 in that center portion 310 and outer portion 320 do not meet at an angle. Furthermore, voice coil former 350 attaches to a “bottom extremity” of first sloping region 315.

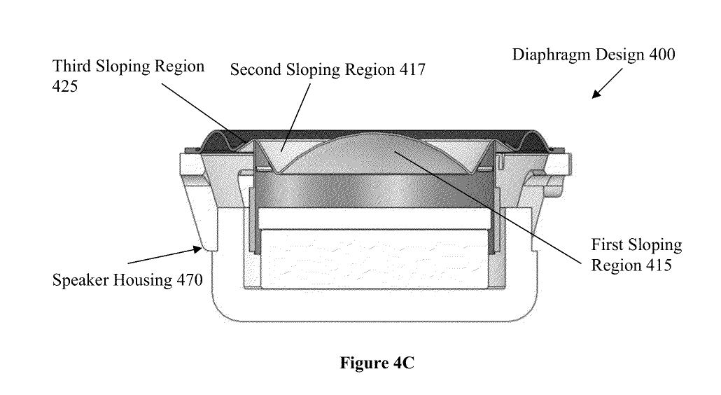

FIG. 4A shows a cross sectional view of W-shape diaphragm design 400. Unlike the prior embodiments shown in FIGS. 2-3, design 400 has a center portion 410 with two sloping regions, namely first sloping region 415 and second sloping region 417. Regions 415 and 417 have different sloping directions and couple at first angle 419. First sloping region 415 has a convex dome shape, which is defined by a height (h) and a diameter (dia). Those of skill in the art will appreciate that first sloping region 415 can be configured in any convex non-dome shape. For example, region 415 can include irregular folds throughout.

Design 400 has an outer portion 420, which is similar to the outer portions 220 and 320 of designs 200 and 300, respectively. Outer portion 420 meets with center portion 410 at third angle 422. Outer portion 420 is shaped with a second angle 424. Angles 419, 422, and 424 are oriented and configured such that the cross-sectional view of center portion 410 and outer portion 420 resemble a “W” shape. While FIG. 4 shows angles 419, 422, and 424 as acute angles, obtuse angles are also contemplated.

FIG. 4B shows a perspective view of diaphragm design 400 coupled with a speaker housing 470. FIG. 4C shows a cross sectional view of diaphragm design 400 and speaker housing 460.

Diaphragm design 400 is merely one of many W-shape diaphragm designs that can be used consistently with the inventive subject matter.

Those of ordinary skill in the art will appreciate that second sloping region 417 can be configured with many different combinations of slopes and lengths, in order to optimize the overall sound characteristics of center portion 410. For example, sloping regions 415 and 417 can be sized and configured such that center of mass 460 is lowered or raised, as needed. In addition, sloping regions 415 and 417 can be sized and configured in order to vary the point of attachment of voice coil former 450. Center portion 410 advantageously includes two sloping regions in order to allow greater flexibility in designing a diaphragm and to provide a shallower transducer.

From a perspective view, voice coil former 450 has a cylindrical shape and outer portion 420 has a dome shape. However, those of skill in the art will appreciate that other shapes can also be used consistently with the inventive subject matter discussed herein. For example, voice coil former 450 can be an oval-shaped cylinder, or even an irregular cylinder. Similarly, center portion 420 can comprise an oval-shaped dome, or even a dome with folds and designs included therein.

Design 400 shows center portion 410 and outer portion 420 as two separate components, which overlap at third sloping region 425. Portions 410 and 420 can be manufactured of two separate materials according to their function: center portion 410 can be made of a stiff material to function as a speaker diaphragm, while outer portion 420 can be made of an elastic material to function as a speaker surround/suspension. Portions 410 and 420 overlap at third sloping region 425 and are affixed together. Those of skill in the art will appreciate that portions 410 and 420 can also be configured as one integral component, with different materials at the different portions, as needed.

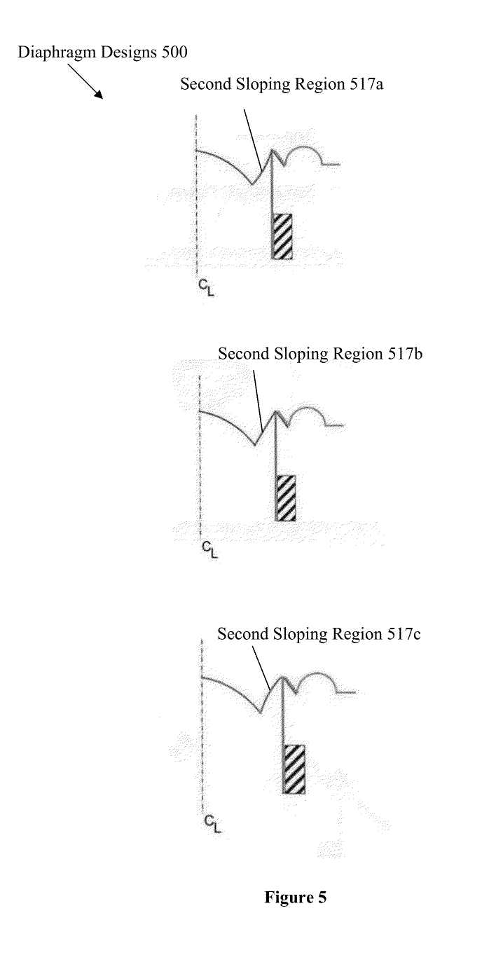

FIG. 5 shows three different embodiments of a diaphragm design 500. In the first embodiment, second sloping region 517a is concave, similar to second sloping region 417 of diaphragm design 400. In the second embodiment, second sloping region 517b has a substantially constant slope. In the third embodiment, second sloping region 517c has a convex shape. FIG. 5 shows how the second sloping region of the center portion can be configured with different slopes. One of skill in the art will appreciate that second sloping region can also include additional sloping regions, such as folds, corrugated patterns, and/or undulations.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A radiating surface for a transducer assembly comprising:
a center portion disposed in a center of a voice coil former and having a first sloping region and a second sloping region, wherein the first and second sloping regions couple at a first angle;
an outer portion disposed outside the center of the voice coil former and having a third sloping region and a fourth sloping region, wherein the third and fourth sloping regions couple at a second angle; and
wherein the center portion is coupled with the outer portion at a third angle.

2. The transducer assembly of claim 1, wherein the center portion is convex.

3. The transducer assembly of claim 1, wherein the first sloping region has a constant slope.

4. The transducer assembly of claim 1, wherein the third angle is configured to couple with the voice coil former.

5. The transducer assembly of claim 1, wherein the second sloping region is concave.

6. The transducer assembly of claim 1, wherein the second sloping region is convex.

7. The transducer assembly of claim 1, wherein the second sloping region has a constant slope.

8. The transducer assembly of claim 1, wherein first, second, and third angles are 45 degrees.

9. The transducer assembly of claim 1, wherein first, second, and third angles are acute angles.

10. The transducer assembly of claim 1, wherein the second sloping region has a length and slope that is configured to place a center of mass of the diaphragm below a height of the voice coil former.

11. The transducer assembly of claim 1, wherein the center portion and the outer portion are one integral unit.

12. The transducer assembly of claim 1, wherein the center portion and the outer portion are two separate units affixed together at a point outside the center of the voice coil former.

13. The transducer assembly of claim 1, wherein the first sloping region and the second sloping region are one integral unit.

14. The transducer assembly of claim 1, wherein the first sloping region and the second sloping region are two separate units affixed together at a point outside the center of the voice coil former.

15. The transducer assembly of claim 1, wherein the center portion comprises a dome diaphragm.

16. The transducer assembly of claim 1, wherein the outer portion comprises a surround suspension.

17. The transducer assembly of claim 1, wherein the center portion and the outer portion have an oval circumference.
